(19) United States
(12) Patent Application Publication
(10) Pub. No.: US 2007/0239965 A1
(43) Pub. Date: Oct. 11, 2007

(54) Inter-partition communication

(76) Inventors: Saul Lewites, Hillsboro, OR (US); Thomas Schultz, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/394,757

(22) Filed: Mar. 31, 2006

(51) Int. Cl. G06F 15/00

(52) U.S. Cl. 712/13

(57) ABSTRACT

In a many-core processor based system with many logical processing cores and a system memory, configuring the system so that the cores are segregated into a several partitions, each partition having at least one core and an area of the system memory allocated exclusively for the use of programs executing in the partition (partition local memory), allocating an inter-partition area of the system memory distinct from any partition local memory and inaccessible to an operating system executing in any partition configuring the inter-partition area so that a sending program executing in a sending partition is operable to write to the inter-partition area using a driver executing in the sending partition and so that a receiving program executing in a receiving partition is operable to read from the inter-partition area using a driver executing in the receiving partition.

### CROSS-REFERENCE TO RELATED APPLICATION

The present application is related to pending U.S. patent application Ser. No. 11/027,253 entitled “System and Method for Implementing Network Security Using a Sequestered Partition,” Attorney Docket Number 42P20903, and assigned to the assignee of the present invention.

### BACKGROUND

Processor-based systems, such as personal computers, servers, laptop computers, personal digital assistants (PDAs) and other processor-based devices, such as “smart” phones, game consoles, set-top boxes and others, may be multiprocessor or multi-core systems. For example, an Intel® architecture processor in such a system may have two, three four or some other number of cores. Such multiprocessor or multi-core systems are generally referred to as many core systems in the following. In some many core systems, some of the cores may be logical cores, such as for example the two logical processing elements provided by processors equipped with Intel Hyper Threading Technology® while in others, the cores may be located on a single physical component such as in an Intel Core Duo® processor. Typically, in such systems, all the cores share access at the hardware level to system memory which may be for example, DRAM, SDRAM, RDRAM or other read-write memory.

### BRIEF DESCRIPTION OF THE DRAWINGS

FIG. 1 depicts a many core system in one embodiment.

FIG. 2 depicts processing in one embodiment.

### DETAILED DESCRIPTION

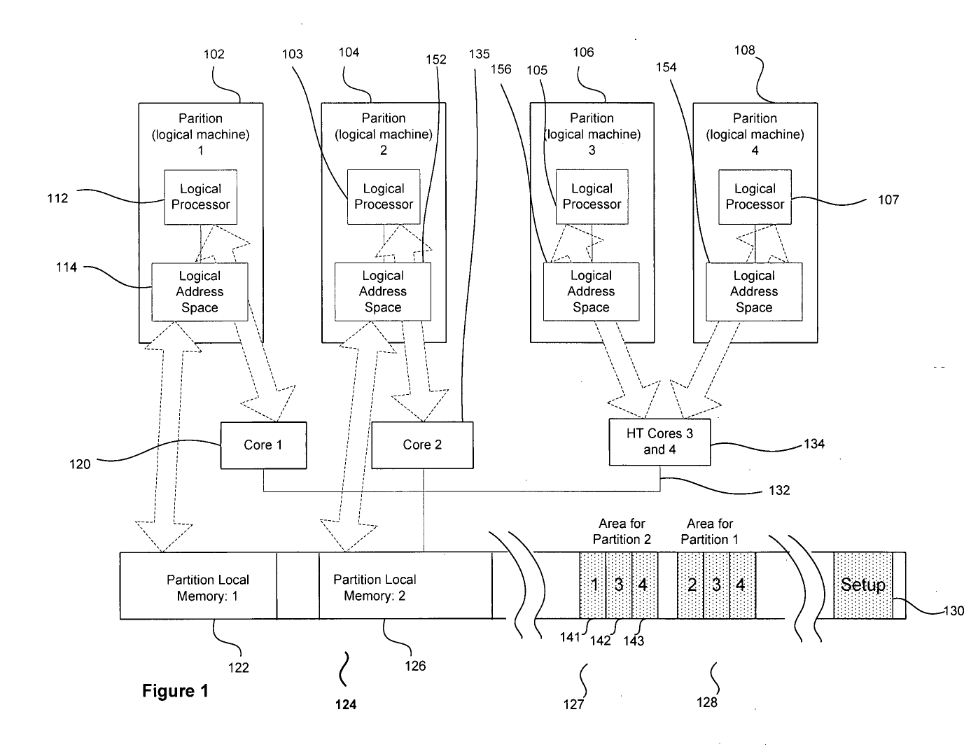

FIG. 1 depicts a many core system in one embodiment with three cores, of which core 1, 120 and core 2, 135 are implemented in hardware as separate cores in a multi-core processor such as an Intel Core Duo processor, or in an alternative embodiment, as separate processors, while two logical cores 3 and 4 are presented by a single physical core or processor 134 with two logical processing elements such as for example an Intel processor with Hyper-Threading (HT) Technology. The cores are interconnected by a system bus or buses 132 and have hardware connectivity with a system memory 124. The system bus may also be connected to a variety of peripheral devices (not shown) such as input and output devices among many others, as is known.

In this embodiment, a firmware-based program executes at or around boot time in the many core system and configures it as shown. Specifically, in the example shown, the firmware program uses the ACPI (Advanced Configuration and Power Interface) tables produced by the BIOS (Basic Input Output System) to partition the system so that one or more processors, a portion of system memory and possibly a sub-set of the peripheral devices, may be segregated into each partition. An operating system executing in one partition may then be unable to access or use any elements such as a processor, processor core, peripherals, or memory that are part of another partition.

In the example shown, there are four partitions numbered 1-4, at 102, 104, 106 and 108 respectively. Each partition may be thought of as having a logical processor, such as those depicted at 112, 103, 105 and 107, which is mapped to an actual core; and a logical memory as depicted at 114, 152, 156 and 154, which maps to an area of system memory. Thus for example, the system memory 124 is partitioned by the firmware into memory areas local to each partition such as area 1 (122) local to partition 1 and mapped to 114; area 2 (126) local to partition 2 and mapped to 152; and so on (memory areas mapped for partitions 3 and 4 are omitted for clarity).

In this embodiment, the firmware at boot time further allocates areas of memory for inter-partition communication. These include inter-partition input areas such as 127 and 128, and an inter-partition communication setup area, 130. Generally, there is an inter-partition input area for each partition, though only two areas are depicted in the figure for clarity: the input area for partition 1 at 128; and the input area for partition 2 at 127. Furthermore, each input area is then subdivided in this example into sub regions termed channels so that input from a specific sending partition to the input area of a receiving partition is directed exclusively to a specific channel. Thus for example, the input area 127 for partition 2 is further divided into channels 141, 142, and 143 for input to partition 2 from partitions 1, 3 and 4 respectively. The input area for partition 1 is subdivided in an analogous way.

The inter-partition setup area 130 may be used to configure communications between the partitions in order for sending partition to send data to a receiving partition, the sending partition generally uses information relating to the location of the receiving partition's input area. Furthermore, signaling between the sending and receiving partition may occur using interrupts, in one embodiment, and thus the sending partition in general uses the processor and interrupt vector to send an inter-processor interrupt (IPI) once the data is transferred. Therefore, the setup area may contain, among other data, the starting address and size of each input area; the number of channels to create per input area; a processor identifier, an interrupt vector, and starting address for each channel.

Many variations on the system depicted in FIG. 1 are possible in other embodiments. The number of physical and/or logical cores in the system may vary from two, three, or four, to many. The number of partitions in the system may vary from two to any number required for a particular application. Generally, the number of partitions is no more than the number of available cores. Furthermore, the order in which local partition memory is provided in terms of the physical locations of the system RAM may be arbitrary and differ from that shown in the figure. In some instances, partitions may only include a processor and access to certain peripherals on the system bus but not have any associated RAM such e.g. when a partition is acting as a trusted program module. The exact sizes of the input areas for each partition may vary, as may the channel sizes; in some embodiments channels may not be used. Furthermore, in some systems, some subset of the partitions may not participate in inter-partition communication using the inter-partition areas, while other partitions may participate. While the setup area may contain information analogous to that described above, other information may also be provided. In some embodiments, mechanisms other than interrupts may be used to signal between partitions.

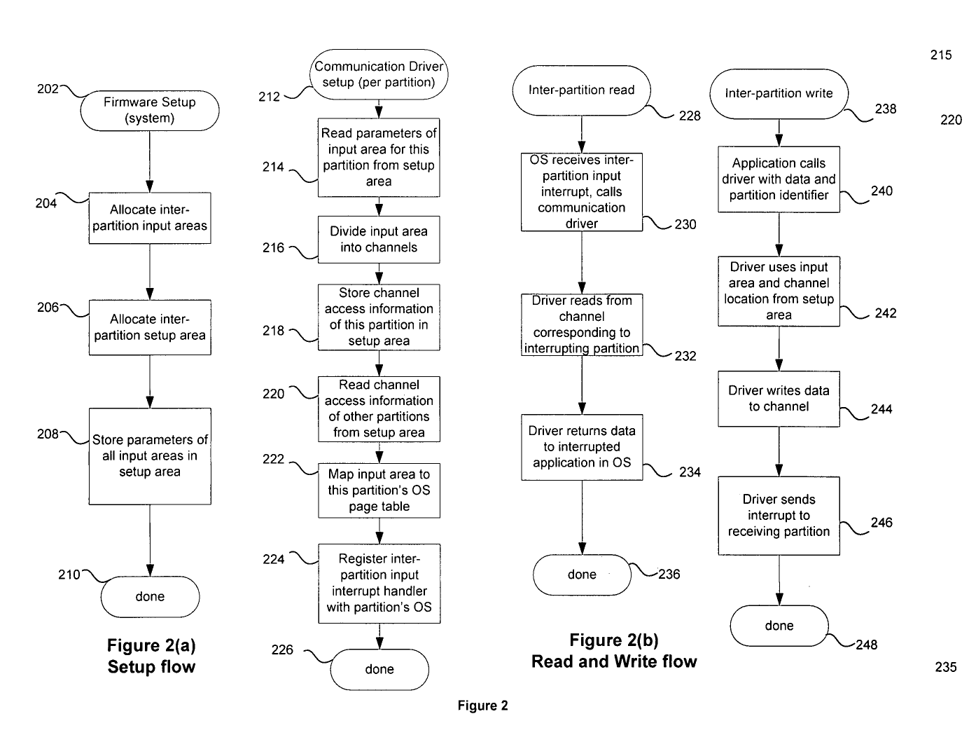

To more clearly describe the process of initial setup of the system depicted in FIG. 1, the flowcharts of FIG. 2(a) show setup processing in one embodiment to initialize a partitioned system and to create the state depicted in FIG. 1. A system-wide portion of the setup is performed by firmware as depicted in the figure at 202-210; and a partition-specific part is performed by a program executing within a partition e.g. a driver that allows an operating system to use the inter-partition areas for communication as depicted in the figure at 212-226. The flowcharts depict only processing related to the creation and setup of the inter-partition areas; other processing related to the creation of partitions such as the allocation of processors and partition-local memory is omitted for clarity.

The setup performed by firmware in this embodiment, 202, first allocates the inter-partition input areas like 127 and 128 (FIG. 1) at 204. These inter-partition areas may not be of the same sizes. The inter-partition input areas (input areas) may be outside the local memory regions of the partitions and therefore not directly accessible to the operating systems, if any, that may be executing in the partitions. The firmware then allocates the setup area that is used by the drivers or other programs within each partition to configure the input areas at 206. At 208, the firmware stores the addresses and sizes of the input areas in the setup area. The firmware may also have the number of partitions that may participate in inter-partition communication, and thus the number of channels required per input area. This number may also be stored in the setup area at 208 and the inter-partition portion of firmware-executed setup then concludes at 210.

Further configuration is performed by a communication driver for each partition that provides the interface for inter-partition communication. The driver in the depicted embodiment when executed initially performs the setup actions shown in the flowchart at 212-228. At 214, the driver reads the location and size of the input area for the partition in which the driver is executing (its parent partition), and the number of partitions that are potential senders. It then divides the input area into channels at 216 based on the number of partitions that may be senders to its parent partition, allocating space to each sending channel depending on factors such as available space in the input area and the expected bandwidth of communication between the sending partition and its parent partition. This information may be based in part on user-defined parameters read at boot-time. The driver then stores parameters for each channel including its location and an interrupt identifier or vector that is associated with the channel in the setup area at 218, in this embodiment. The driver then initializes its parameters for sending from its parent by reading the channel information from other partitions at 220. As is known in the art, some synchronization between drivers may be necessary between 218 and 220 to ensure that no driver reads configuration information for another partition before all drivers have written configuration information for their respective parent partitions. The details of this synchronization are omitted for clarity.

The operating system executing in a partition may not have direct access to the input area, and all access is thus generally performed by the communication driver using a page mapped in the page table of the operating system of the partition in this embodiment. The driver performs this mapping at 222. Finally, the driver registers itself as an interrupt handler for interrupts targeted to the OS with a vector indicating that inter-partition communication has occurred. A communication driver in a sending partition generates an inter-partition interrupt (IPI), vectored to a processor and the corresponding communication driver in the receiving partition, to signal that data has been placed in the input area of the receiving partition. With this the initial setup performed by the communication driver for each partition is complete.

FIG. 2(b) depicts the actual communication process that is executed to accomplish inter-partition communication once setup as depicted in FIG. 2(a) is complete. The inter-partition read process 228 begins when an inter-process interrupt (IPI) is received by an operating system (OS) in a receiving partition. The OS then invokes the communication driver registered as the handler for the IPI in the setup at 224 (FIG. 2(a)), at 230. Information relating to the sending partition is passed along with the IPI and available to the driver, generally as a parameter. The driver then reads from the channel in the receiving partition's input area that corresponds to the sending partition. The data is read and then passed back to the OS for its use. Alternatively, the OS may access the data through the mapping provided in the page table as previously described with reference to 222 (FIG. 2(a)). The input area may need to be further managed after the write and read are complete, because in a typical embodiment it may be maintained as a ring buffer, a data structure well known in the art. Details of ring buffer management are therefore omitted in this paper.

From the writing partition's point of view, the processing is as shown in FIG. 2(b) starting at 238. First, the process or program initiating the inter-partition write may call the communication driver in its partition to initiate the write at 240. This call may be similar to a call to a driver for an output device e.g. a printer or network adapter. The data to be sent, and an identifier for the partition to receive the data, are provided to the driver; this may be as a parameter or via another data passing mechanism such as a global data passing area among other alternatives. The driver in this embodiment then uses the information previously stored in the setup area at 208 and 218 (FIG. 2(a)) to determine the input area for the data and the channel within the input area, depending on the identifier for its parent partition and for the receiving partition at 242. It then proceeds to write the data, 244. Once the data is written the driver initiates an IPI to signal the receiving partition and to alert it to the communication event, at 246 so that the reading processing that was described above with reference to FIG. 2(b) can occur.

As would be appreciated by one in the art, many variations of the processing shown in FIGS. 2(a) and 2(b) may be used in other embodiments. For example, in some embodiments, different drivers or programs may handle setup, sending and receiving, or those functionalities may be combined with other inter-partition or other communication functionalities in other programs or drivers. The actual order of the processing in setup may vary, for example, the mapping of the input area at 222 in FIG. 2(a) may in some embodiments occur at any point after the processing at 214. The actual mechanisms of registering, receiving and handling interrupts may vary widely across platforms, operating systems, and implementations, and are not detailed; such details in any embodiment should not be construed to limit the invention. In some embodiments an operating system per se may not be present, rather, a control program, executive, monitor or other type of program may be the primary operating process in a partition. The implementation languages and other implementation details may be varied indefinitely as is known, and thus a wide variety of embodiments are possible.

In the preceding description, for purposes of explanation, numerous specific details are set forth in order to provide a thorough understanding of the described embodiments, however, one skilled in the art will appreciate that many other embodiments may be practiced without these specific details.

Some portions of the detailed description above are presented in terms of algorithms and symbolic representations of operations on data bits within a processor-based system. These algorithmic descriptions and representations are the means used by those skilled in the art to most effectively convey the substance of their work to others in the art. The operations are those requiring physical manipulations of physical quantities. These quantities may take the form of electrical, magnetic, optical or other physical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

In the description of the embodiments, reference may be made to accompanying drawings. In the drawings, like numerals describe substantially similar components throughout the several views. Other embodiments may be utilized and structural, logical, and electrical changes may be made. Moreover, it is to be understood that the various embodiments, although different, are not necessarily mutually exclusive. For example, a particular feature, structure, or characteristic described in one embodiment may be included within other embodiments.

Further, a design of an embodiment that is implemented in a processor may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, data representing a hardware model may be the data specifying the presence or absence of various features on different mask layers for masks used to produce the integrated circuit. In any representation of the design, the data may be stored in any form of a machine-readable medium. An optical or electrical wave modulated or otherwise generated to transmit such information, a memory, or a magnetic or optical storage such as a disc may be the machine readable medium. Any of these mediums may “carry” or “indicate” the design or software information. When an electrical carrier wave indicating or carrying the code or design is transmitted, to the extent that copying, buffering, or re-transmission of the electrical signal is performed, a new copy is made. Thus, a communication provider or a network provider may make copies of an article (a carrier wave) that constitute or represent an embodiment.

Embodiments may be provided as a program product that may include a machine-readable medium having stored thereon data which when accessed by a machine may cause the machine to perform a process according to the claimed subject matter. The machine-readable medium may include, but is not limited to, floppy diskettes, optical disks, DVD-ROM disks, DVD-RAM disks, DVD-RW disks, DVD+RW disks, CD-R disks, CD-RW disks, CD-ROM disks, and magneto-optical disks, ROMs, RAMs, EPROMs, EEPROMs, magnet or optical cards, flash memory, or other type of media/machine-readable medium suitable for storing electronic instructions. Moreover, embodiments may also be downloaded as a program product, wherein the program may be transferred from a remote data source to a requesting device by way of data signals embodied in a carrier wave or other propagation medium via a communication link (e.g., a modem or network connection).

Many of the methods are described in their most basic form but steps can be added to or deleted from any of the methods and information can be added or subtracted from any of the described messages without departing from the basic scope of the claimed subject matter. It will be apparent to those skilled in the art that many further modifications and adaptations can be made. The particular embodiments are not provided to limit the claimed subject matter but to illustrate it. The scope of the claimed subject matter is not to be determined by the specific examples provided above but only by the claims below.

What is claimed is:

1. A method comprising:
in a many-core processor based system comprising a plurality of logical processing cores and a system memory,
configuring the system, to create a configuration wherein the plurality of cores is segregated into a plurality of partitions, each partition having at least one core and a partition local memory allocated exclusively for the use of programs executing in the partition;
allocating an inter-partition area of the system memory distinct from any partition local memory and inaccessible to an operating system executing in any partition; and
configuring the inter-partition area to create a configuration enabling a sending program executing in a sending partition is operable to write to the inter-partition area using a driver executing in the sending partition and further enabling a receiving program executing in a receiving partition is operable to read from the inter-partition area using a driver executing in the receiving partition.

2. The method of claim 1 wherein allocating the inter-partition area further comprises allocating a separate region of memory as an input area for each partition; and executing a protocol for communication further comprising the sending program in the sending partition writing data to the input area for the receiving partition to send data to the receiving program in the receiving partition; and the receiving program in the receiving partition then reading the data from the input area for the receiving partition to receive data from the sending program in the sending partition.

3. The method of claim 1 further comprising firmware of the platform performing the configuring of the system and the allocation of the inter-partition area of the memory; and wherein the protocol for communication is executed at least in part by the driver executing in the sending partition and the driver executing in the receiving partition.

4. The method of claim 2 further comprising the driver executing in the sending partition generating an interrupt targeted to the receiving program after the writing the data to the input area; and the driver executing in the receiving partition performing the reading the data from the input area in response to the receiving program receiving the interrupt.

5. The method of claim 3 wherein each inter-partition block designated as input to a receiving partition is further divided into channels, each channel exclusively designating a portion of the inter-partition block into which a program executing in a specified partition may write data.

6. The method of claim 5 wherein the driver executing in the receiving partition further comprises:
a driver of an operating system executing in the receiving partition
mapping the inter-partition block to a page of a page table of an operating system executing in the receiving partition;
performing the dividing of the inter-partition block into channels;
associating a partition identifier and interrupt vector with each channel; and
registering the driver as the handler for the interrupt with the operating system.

7. The method of claim 5 further comprising:
the firmware allocating an inter-partition setup area; and
the driver of the operating system of the receiving partition
determining the location and size of the inter partition block of the receiving partition from the setup area;
dividing the inter-partition block into channels; and
storing interrupt vector and location information for each channel in the setup area.

8. A tangible, machine readable medium having stored thereon data that when accessed by a machine causes the machine to perform a method, the method comprising:
in a many-core processor based system comprising a plurality of logical processing cores and a system memory,
configuring the system to create a configuration wherein the plurality of cores is segregated into a plurality of partitions, each partition having at least one core and a partition local memory allocated exclusively for the use of programs executing in the partition;
allocating an inter-partition area of the system memory distinct from any partition local memory and inaccessible to an operating system executing in any partition; and
configuring the inter-partition area to enable a sending program executing in a sending partition to write to the inter-partition area using a driver executing in the sending partition and further to enable a receiving program executing in a receiving partition to read from the inter-partition area using a driver executing in the receiving partition.

9. The machine readable medium of claim 8 wherein allocating the inter-partition area further comprises allocating a separate region of memory as an input area for each partition; and executing a protocol for communication enabling the sending program in the sending partition to write data to the input area for the receiving partition to send data to the receiving program in the receiving partition; and the receiving program in the receiving partition to read the data from the input area for the receiving partition to receive data from the sending program in the sending partition.

10. The machine readable medium of claim 8 wherein the method further comprises firmware of the platform performing the configuring of the system and the allocation of the inter-partition area of the memory; and wherein the protocol for communication is executed at least in part by the driver executing in the sending partition and the driver executing in the receiving partition.

11. The machine readable medium of claim 10 wherein the method further comprises the driver executing in the sending partition generating an interrupt targeted to the receiving program after the writing the data to the input area; and the driver executing in the receiving partition performing the reading the data from the input area in response to the receiving program receiving the interrupt.

12. The machine readable medium of claim 10 wherein each inter-partition block designated as input to a receiving partition is further divided into channels, each channel exclusively designating a portion of the inter-partition block into which a program executing in a specified partition may write data.

13. The machine readable medium of claim 12 wherein the driver executing in the receiving partition further comprises:
a driver of an operating system executing in the receiving partition
mapping the inter-partition block to a page of a page table of an operating system executing in the receiving partition;
performing the dividing of the inter-partition block into channels;
associating a partition identifier and interrupt vector with each channel; and
registering the driver as the handler for the interrupt with the operating system.

14. The machine readable medium of claim 12 wherein the method further comprises: the firmware allocating an inter-partition setup area; and
the driver of the operating system of the receiving partition
determining the location and size of the inter partition block of the receiving partition from the setup area;
dividing the inter-partition block into channels; and
storing interrupt vector and location information for each channel in the setup area.

15. A system comprising:
a plurality of logical processing cores and a system memory,
a plurality of partitions into which the plurality of cores is segregated, each partition having at least one core and a partition local memory allocated exclusively for the use of programs executing in the partition;
an inter-partition area of the system memory distinct from any partition local memory and inaccessible to an operating system executing in any partition, the inter-partition area so configured that a sending program executing in a sending partition is operable to write to the inter-partition area using a driver executing in the sending partition and a receiving program executing in a receiving partition is operable to read from the inter-partition area using a driver executing in the receiving partition.

16. The system of claim 15 wherein:
the inter-partition area further comprises a separate region of memory as an input area for each partition; and
the sending partition and the receiving partition are further to execute a protocol for communication wherein the sending program in the sending partition writes data to the input area for the receiving partition to send data to the receiving program in the receiving partition; and the receiving program in the receiving partition then reads the data from the input area for the receiving partition to receive data from the sending program in the sending partition.

17. The system of claim 15 further comprising firmware of the platform to perform the configuring of the system and the allocation of the inter-partition area of the memory; and wherein the protocol for communication is executed at least in part by the driver executing in the sending partition and the driver executing in the receiving partition.

18. The system of claim 16 further comprising the driver executing in the sending partition to generate an interrupt targeted to the receiving program after the writing the data to the input area; and the driver executing in the receiving partition to perform the reading the data from the input area in response to the receiving program receiving the interrupt.

19. The system of claim 17 wherein each inter-partition block designated as input to a receiving partition is further divided into channels, each channel exclusively designating a portion of the inter-partition block into which a program executing in a specified partition may write data.

20. The system of claim 19 wherein the driver executing in the receiving partition further comprises:
a driver of an operating system executing in the receiving partition
to map the inter-partition block to a page of a page table of an operating system executing in the receiving partition;
to perform the dividing of the inter-partition block into channels;
associating a partition identifier and interrupt vector with each channel; and
to register the driver as the handler for the interrupt with the operating system.

21. The system of claim 19 further comprising:
the firmware to allocate an inter-partition setup area; and
the driver of the operating system of the receiving partition
to determine the location and size of the inter partition block of the receiving partition from the setup area;
to divide the inter-partition block into channels; and
to store interrupt vector and location information for each channel in the setup area.
